(19) United States
(12) Patent Application Publication
(10) Pub. No.: US 2012/0025131 A1
(43) Pub. Date: Feb. 2, 2012

(54) CONDUCTIVE PREPARATION AND METHOD FOR THE PRODUCTION THEREOF

(75) Inventor: Stefan Forero, Weidenberg (DE)

(73) Assignee: Futurecarbon GMBH, Bayreuth (DE)

(21) Appl. No.: 12/998,891

(22) PCT Filed: Dec. 8, 2009
(86) PCT No.: PCT/EP2009/066626

§ 371 Date: Oct. 4, 2011

(30) Foreign Application Priority Data
Dec. 11, 2008 (DE) 102008061834.9
Mar. 30, 2009 (DE) 102009015493.0

(51) Int. Cl. H01B 1/24; H01B 1/20; C09K 5/00

(52) U.S. Cl. 252/71; 252/500; 252/502; 252/74; 252/511

(57) ABSTRACT

The present invention relates to a conductive preparation, in particular an electrically and/or thermally conductive preparation, which is characterized in that it has a first, at least temporarily, liquid phase and at least one, preferably at least two conductive additive(s) provided in the first phase. A method for producing a conductive preparation of this type is characterized by the following steps: A) Providing a first, at least temporarily, liquid phase; B) Adding at least one conductivity additive, preferably at least two conductivity additives into the first phase; C) Mixing the first phase and the at least one conductivity additive into a homogeneous state.

The present invention relates to a conductive preparation as well as a method for producing such a conductive preparation.

In particular, the present invention also relates to a method for producing a plastic preparation. In addition, the invention also relates to a plastic preparation. The plastic preparation may involve a polymer preparation, for example.

In particular, the invention relates to preparations that are thermally and/or electrically conductive. Most particularly preferred, the invention relates to an electrically conductive preparation.

Today's electrically conductive polymer preparations contain, for example, graphite, carbon black, silver, carbon fibers, metal-coated conductive and non-conductive particles, or mixtures thereof. In these cases, obtaining a conductivity of 1 mS/cm, for example, is associated with a drastic increase in the viscosity due to the necessary high content of filler, 5-80 wt %, depending on the additive in each case. Therefore, the electrically conductive preparations that are available at the present time are difficult to process.

Today's thermally conductive polymer preparations contain metals such as silver or ceramics such as Al₂O₃, AlN, Si₃N₄, SiO₂, BN, metal-coated conductive and non-conductive particles, or mixtures thereof. In these cases, obtaining a heat conductivity of 3 W/mK, for example, again is associated with a drastic increase in the viscosity due to the necessary high content of filler, 50-80 wt. %, depending on the additive in each case. Therefore, the thermally conductive preparations that are available at the present time are also difficult to process.

The solutions to the processing problem that are most common at the present time provide for the addition to the CNT [carbon nanotube]/resin system either of surface-active substances or solvents. However, it is known that these measures lead to other problems in drying and crosslinking and may lead to a degradation of the mechanical and chemical properties of the crosslinked material.

The problem of the invention is to provide a method for the production of a conductive preparation as well as a conductive preparation, which do not have the above-named disadvantages.

This problem is solved by the conductive preparation having the features according to the independent patent claims 1 and 7, as well as by the method for the production of such a conductive preparation having the features according to the independent patent claims 8 and 12. Further features and details of the invention can be taken from the subclaims, the description and the examples. Features and details that are described in connection with the aspects of the method according to the invention, of course, thus apply also in connection with the aspects of the preparation according to the invention, and vice versa. Likewise, features that are described in connection with one aspect of the method or one aspect of the preparation, of course, also apply in connection with the other aspects of the method or other aspects of the preparation.

According to the first aspect of the invention, a conductive preparation, in particular an electrically and/or thermally conductive preparation is provided, having a first, at least temporarily liquid phase, as well as at least one conductivity additive provided in the first phase.

Thus, when the first phase is present in the liquid state, this is not an issue. The first phase may be a liquid during the entire production and processing procedure, or, however, only in one or more process steps, for example during a mixing process or during the application. Therefore, powder coatings and the like are also included.

The term “liquid” shall be understood here, in particular, in the physical sense, so that, of course, viscous and/or non-Newtonian liquids and melts and the like are also included.

In particular, a conductive preparation according to the invention, especially an electrically and/or thermally conductive preparation is preferred, which can be obtained by

A) Providing a first, at least temporarily, liquid phase;

B) Adding at least one conductivity additive, preferably at least two conductivity additives into the first phase;

C) Mixing the first phase and the at least one conductivity additive into a homogeneous state.

Any mixing sequence is possible in this process. Thus, for example, first one additive alone or two or more pre-mixed additives can be mixed with the first, at least temporarily, liquid phase. Additional additives can be mixed in thereafter, without this being absolutely necessary for the invention.

This type of preparation can be utilized in a great many ways. Advantageously, such a preparation can be utilized as a heatable coating, as a heatable mold, or can be used in heatable coatings or in heatable molds, and the like. Of course, the invention is not limited to these named examples. Several additional advantageous, but not exclusive application possibilities are named in the further course of the description.

Advantageously, at least one other conductivity additive can be provided in the first phase.

Preferably, the first and/or second conductivity additive can be formed based on carbon. The invention is not limited to specific materials in this case. Several advantageous, but non-exclusive examples will be explained in more detail in the further course of the description.

Preferably, the preparation can have at least one binder and/or at least one additional additive. A binder is generally a binding agent that holds together substances and materials. The invention is not limited to specific binder materials, which can be advantageously formed organically or inorganically. Each time depending on the embodiment, other additives can also be mixed in, wherein in this respect also the invention is not limited to specific additives. Several advantageous, but non-exclusive examples for binders and additives are named in the further course of the description.

In another embodiment, the preparation may have electrical contacts or means for installing electrical contacts.

Preferably, the preparation can be embodied as a coating. For example, the coating may be a lacquer or paint. Advantageously, a substrate may be coated with the coating. The lacquer or paint can then represent the outermost coating of the substrate, whereby other coatings can be introduced under the lacquer or paint. Of course, it is also conceivable that the lacquer or paint functions as a type of primer. This means that still other layers, for example, additional lacquer or paint layers, protective layers or the like can be applied on top of the lacquer or paint that represents the conductive preparation and is applied onto the substrate. A product containing the preparation according to the invention, for example, may have one or more coatings, whereby the coating according to the invention may be the lowermost coating, the uppermost coating or another coating lying in between other layers.

Advantageously, the conductive preparation may be embodied as a heating element or for a heating element.

Preferably, the conductive preparation may be applied onto a substrate or can be formed so that it can be introduced onto a substrate.

The invention is not limited to specific forms or substances for the substrate. For example, smooth or rough substrates are possible, which can be coated, for example, by one of the methods described further below. If needed, for example, a bonding agent may be used. Likewise, for example, all types of textiles and fibers may serve as the substrate, for example, woven materials, non-woven materials, yarns, natural and synthetic fibers, and the like.

A conductive preparation according to the invention can be exploited and used for the most varied purposes. In general, the preparation can be used everywhere where something needs to be preheated or heated, for example, in connection with heatable mirrors, heatable canvas covers, in particular truck tarpaulins, wall coverings, wallpaper, flooring and the like, defrosting equipment for machinery, pipelines, aircraft, particularly aircraft wings, in the field of textiles, heating mats or blankets, heating covers, heating canvas covers, and the like. In this way, an application can be provided both indoors as well as outdoors. A corresponding preparation, for example a lacquer or paint, can be provided as a component of substrates that are designed, for example, in the form of films, textiles, flexible materials and the like. In this way, the preparation can be provided as a coating on the substrate, but also as material components within the substrate. Another preferred field of application of the present invention can be the heating of devices, particularly medical devices. For example, one can think of blood glucose meters as medical devices. Blood glucose meters only operate correctly and accurately if they are suitably kept at certain temperatures. For example, this is important for athletes when they are outdoors. It is possible to heat these types of devices with the conductive preparation according to the invention. Of course, it is also possible to only heat up test strips.

Advantageously, the conductive preparation may be applied onto a substrate or can be formed so that it can be introduced onto a substrate. Such an embodiment particularly has the advantage that the preparation and thus the substrate can be heated uniformly. In particular, such a heating device can be produced in a structurally simple way, since the windings of heating wires, coils, pipelines, textured heating layers and the like that were previously necessary can be dispensed with.

Preferably, a conductive preparation is provided that is introduced onto a substrate or is formed in a substrate, which is provided with electrical contacts, by means of which an electrical voltage can be applied to the conductive preparation. The conductive preparation can then be heated in a desired way by means of the electrical current flowing through the preparation.

Advantageously, the conductive preparation may be formed as a heating element. In another embodiment, the conductive preparation can be formed for a heating element. In the first case, the conductive preparation itself represents the heating element. In the second case, the conductive preparation is a component of a heating element, i.e., the element provided in the heating element for the generation of heat.

In addition, a conductive preparation, in particular a plastic preparation is preferred, which is preferably formed in the above-described way according to the invention and which is characterized by at least one base material, particularly a plastic material, as well as at least two additives that are mixed in, wherein at least one additive is preferably formed as a conductivity additive.

In particular, a conductive preparation as described above according to the invention, particularly a plastic preparation is preferred, which can be obtained in that at least two additives are added to a base material, particularly a plastic material, whereby at least one additive is formed as a conductivity additive, and that the individual components are mixed to form a preparation, particularly a plastic preparation.

According to another aspect, a method for the production of a conductive preparation, in particular an electrically and/or thermally conductive preparation, especially a conductive preparation according to the invention as described above, is characterized by the following steps:

A) Providing a first, at least temporarily, liquid phase;

B) Adding at least one conductivity additive, preferably at least two conductivity additives into the first phase;

C) Mixing the first phase and the at least one conductivity additive into a homogeneous state.

Any mixing sequence is possible in this process. Thus, for example, first one additive alone or two or more pre-mixed additives can be mixed with the first, at least temporarily, liquid phase. Additional additives can be mixed in thereafter, without this being absolutely necessary for the invention.

A mixture for a conductive, particularly electrically conductive, and/or heatable coating, for example in the form of a lacquer or paint, can preferably be produced in this way.

Initially, a first phase is applied, which is characterized by the fact that it is liquid, at least temporarily. The invention is not limited to specific phases in this case. For example, the phase can be formed on an aqueous base, e.g., in the form of water. Of course, other types of phases are also possible, for example phases based on plastic, which can be formed, for example, as aqueous, solvent-based or similar phases. Also, the first phase can be embodied in the form of a resin or the like. Of course, combinations of the named examples are also possible. The named examples are purely of an exemplary nature and do not represent an exclusive listing, so that the invention is not limited to the named examples.

At least one conductivity additive is added to the first phase. Optionally, at least one other conductivity additive can be added. Non-exclusive examples for these types of conductivity additives have been named above and are also described in greater detail in the further course of the description.

Preferably, at least one binder and/or at least one other additive can be added.

Advantageously, the conductive preparation can be introduced onto a substrate.

A conductive preparation in the form of a coating, for example in the form of a lacquer or paint, is preferably produced by the method.

Preferably, a conductive preparation in the form of a heating element or in the form of an element for a heating element can be produced by the method.

First, it can be provided that a solution is produced, in which the above-named fillers will then be added in the form of conductivity additive(s), and/or binders and/or other additives. If the first phase is a plastic, it may be necessary that the plastic is dissolved first. Then a mixture or a blend is produced that has a homogeneous state. An extensive dilution by other additives may possibly be produced here.

The conductive preparation that forms therefrom can be applied onto a substrate in different ways, for example, by means of spreading, spraying, brushing, rolling, dipping, soaking, painting, troweling and the like, or also in a direct or indirect printing method, for example, by screen printing, mask printing, pad printing, rotogravure and the like.

In addition, a method for the production of a conductive preparation, especially a plastic preparation, in particular a preparation according to the invention as described above, is preferred, wherein the method is preferably conducted in the way according to the invention as described above, wherein the method is characterized by the fact that at least two additives are added to at least one base material, in particular a plastic material, wherein at least one additive is formed preferably as a conductivity additive, and that the individual components are mixed to form a preparation, in particular a plastic preparation.

In addition, a method for the production of a conductive preparation, especially a plastic preparation, in particular a preparation according to the invention as described above, is preferred, wherein the method is preferably conducted in the way according to the invention as described above, wherein the method is hereby characterized in that a first additive, in particular a conductivity additive, preferably based on carbon, is mixed with a base material, in particular a plastic material; in that a second additive, in particular a conductivity additive, preferably based on carbon, is mixed with a base material, in particular a plastic material; and in that the two mixture parts are mixed to form a preparation, particularly a plastic preparation.

Advantageously, at least one other material and/or at least one other substance is/are mixed in with the base material and/or the preparation.

The conductive preparations advantageously may be formed as thermally and/or electrically conducting. It is preferably provided that the preparation is formed as electrically conducting. This type of preparation is low-ohm due to the use of the at least one conductivity additive, which leads to a good electrical conductivity, since only a small electrical resistance is present. A homogeneous heatability can be produced because of this. It is also assured by the low-ohm property that only small voltages need to be applied to the preparation in order to achieve a good heating.

The advantageous configuration of the individual aspects of the invention will be described in more detail below.

As long as the first phase or the base material is formed based on plastic, advantageously, the invention relates to electrically and/or thermally conductive polymers. The present invention in particular provides polymer preparations with excellent electrical/thermal conductivity and low viscosity. Of course, other plastics are also possible.

The invention particularly relates to all types of polymers (especially reactive resins and corresponding hardeners and accelerators, thermoplastic polymers and elastomers), as well as also carbon particles of different morphology, processing and conditioning, as well as also metal particles of different morphology, processing and conditioning, as well as also ceramic particles of different morphology, processing and conditioning, as well as other conductivity additives.

Further, the invention advantageously relates to a method for the production of a conductive preparation, in particular a polymer preparation, whereby the latter shall contain, in addition to the base material, for example a base polymer, at least two conductivity additives, at least one of which comprises carbon, as well as the preparation produced according to the invention and use thereof.

The conductive preparations may, but need not necessarily, contain other auxiliary materials such as dispersing agents, solvents, stabilizers, etc.

A large number of materials and substances can find application or may be considered in connection with the present invention. Several advantageous, but non-exclusive examples will be explained in more detail in the further course of the description:

The conductivity additives may be formed advantageously based on carbon. Several advantageous, but non-exclusive examples for preferred conductivity additives will be described below, each of which may find use individually, or, however, in any random combination.

Graphite

Graphite is a very frequently occurring mineral and belongs to the order of semimetals and non-metals. In addition to diamond and fullerenes, it is the third stable form (modification) of carbon under normal terrestrial conditions, and for the most part crystallizes in the hexagonal crystal system, and also very rarely in the trigonal crystal system.

Graphite develops opaque, gray to black crystals, in hexagonal, lamellar, flaky or columnar form, which have metallic luster on the crystal surfaces.

In crystalline graphite, parallelly running planar layers, the “basal planes” or “graphene layers” are present. A layer comprises covalently linked hexagons, the carbon atoms of which are sp²-hybridized. Within these planes, the binding energy between the carbon atoms amounts to 4.3 eV, while in contrast, it only amounts to 0.07 eV between the layers. A clear anisotropy of the mechanical, electrical and thermal properties of the graphite results from this extreme directional dependency of the binding forces:

Pure graphite is easily cleaved along the basal plane, but has clearly higher strength along the crystal layers;

It has thermal and electrical isolation orthogonal to the basal planes, but an almost metallic conductivity along the planes.

The conductivity within a plane is made possible by the delocalization of the pi electrons. If the planes have no strong relationship relative to one another, one speaks of turbostratic carbon.

Carbon Nanotubes

Carbon nanotubes (CNTs) are composed of closed graphene layers rolled up to from cylinders. Individual tubes are called “single wall carbon nanotubes” (SWCNTs), while particles of concentrically stacked tubes of increasing diameter are called “multiwall carbon nanotubes” (MWCNTs).

CNTs can be produced by different methods. The most well known include the arc process, the laser ablation method and supported catalytic chemical vapor deposition (CCVD). The latter method is suitable for large-scale production of CNTs. In this way, CNTs of gaseous carbon sources (hydrocarbons, alcohols, CO, CO₂) are formed on metallic, catalytically active substances.

Commercially available SWCNTs have diameters of 0.5-4 nm, and MWCNTs have diameters between 6 and 100 nm. The length of CNTs can amount to several mm.

The physical properties of CNTs correspond largely to those of graphite along the basal planes.

CNTs are utilized today as mechanical reinforcement, electrically and thermally conductive additives in polymers, ceramics and metals. For this purpose, CNTs are often chemically modified on their surface in order to satisfy the requirements of a good dispersability and binding to the matrix. Usually, CNTs are added to the matrix material. Based on the high aspect ratio and the high specific surface, only composites with relatively low CNT content can be prepared.

Carbon Nanofibers

Carbon nanofibers (CNFs) are composed of graphene layers that are stacked on top of one another along the filament axis. The angle (the orientation) of the graphene planes relative to the filament axis is used as a rough distinction. So-called “herringbone” CNFs accordingly possess graphene planes that are disposed at an angle≈90°. These CNFs can be solid or can also be hollow. Their diameters lie in the range of 50 nm-1 μm and their lengths can amount to several mm. In the case when the graphene layers are disposed at an angle=90° to the filament axis, one speaks of “platelet” CNFs. Their diameters lie in the range of 50 nm-500 nm and their lengths can amount to 50 μm. These CNFs are usually produced by CVD. Their applications are found primarily in catalysis as a catalyst support and as active additives in Li-ion batteries or in gas storage.

Carbon Black

Carbon black is a black, powder-form solid which comprises up to 80% or more carbon, depending on the quality and use in each case.

Depending on its specific field of application, carbon black possesses a special property profile, which can be influenced in a targeted manner by the type of production method and by variation of the process parameters.

Carbon black, its properties, production methods, uses and so forth have already been amply described, so that the relevant professional literature will be referenced here.

The first phase or the base material can advantageously be formed based on plastic. Several advantageous, but non-exclusive examples for preferred plastic materials will be described below, each of which may find use individually, or, however, in any random combination.

Polymers

Polymers are understood to be chemical compounds that are constructed of one or several types of uniform units (monomers). Such molecules are mostly of the chain type, but may be branched, and have covalent bonds between the monomers,

Reactive Systems

The basic substances, plastic materials, into which the additives are mixed, for example, involve monomers, oligomers and polymers that contain epoxy groups. For example, they are based on bisphenol-A, bisphenol-F, novolac and others. In addition to aromatic derivatives, they additionally involve aliphatic derivatives. The epoxy resins may be mono-, di-, tri-, tetra- and multi-functional and may comprise all molecular weights.

In addition, they involve mono- and multi-functional cycloaliphatic epoxy resins, such as, e.g., 3,4-epoxycyclohexylmethyl-3,4-epoxycyclohexane carboxylate, bis((3,4-epoxy-cyclohexyl)methyl) adipate and other derivatives of higher molecular weight or also of lower molecular weight.

Another group of basic resins comprises cyanate esters and isocyanates such as, e.g., 2,4-diisocyanato-1-methylbenzene, 1-isocyanato-4-[(4-isocyanatophenyl) methyl]benzene, 1,1-bis(4-cyanatophenyl)ethane, 2,2-bis(4-cyanatophenyl)propane, oligo(3-methylene-1,5-phenylene cyanate) and other derivatives of higher or also of lower molecular weight.

Another group of basic resins comprises linear and branched diols and multi-functional alcohols, oligo, polyester and polyether polyols of all molecular weights.

Another group of base resins comprises reactive polyimide systems. These may contain: monofunctional monomers such as, e.g., N-phenyl maleimide, 2,6-xylyl maleimide, N-cyclohexyl maleimide, etc. and difunctional monomers such as, e.g., 4,4′-diphenylmethane bismaleimide, N,N′-(4-methyl-m-phenylene) bismaleimide, N,N′-phenylene bismaleimide, bisphenol-A diallyl ether, o,o′-diallyl bisphenol-A, polyphenylmethane bismaleimide, polybenzimidazole, etc.

Another group of base resins comprises phenolic resins, which are based on novolac or resol, for example.

Another group of base resins comprises unsaturated polyester and vinyl ester resins.

Another group of base resins comprises alkyd resins. Another group of base resins comprises melamine resins. Another group of base resins comprises polysilanes and silicones. Another group of base resins comprises acrylates. Another group of base resins comprises polyquionoxalines. Another group of base resins comprises pitch and bitumen.

In addition, hardener substances and accelerators are contained, such as amines, amides, amido amines, amino alcohols, amino acids, anhydrides, imidazoles, cyanamides, alcohols, phenols, polyols, cyanates, mercaptans, carboxylic acids, metal complexes, etc., in low, intermediate and high molecular weights. In addition, aqueous and/or solvent-containing resin and/or hardener dispersions are contained.

Thermoplastics

The basic substances involve, e.g., polyolefins such as polypropylene, polyethylene, polybutylene, polyisobutylene, etc.

Another group of base polymers comprises polyamides such as, e.g., polyamide-66, polyamide-12, polyamide-11, polyamide-6, etc.

In addition, polyacrylic polymers such as polymethyl methacrylate, polyacrylonitrile, polyacrylic acid and derivatives, etc. are contained.

Another group of base polymers comprises fluoropolymers such as polytetraflouroethylene, polyvinylidene fluoride, etc.

Another group of base polymers comprises aliphatic and aromatic polyesters, such as, e,g., polyglycols, polyethylene terephthalate, etc.

Another group of base polymers comprises polyimides, such as e.g., polyether imide.

Another group of base polymers comprises poly(aryl) ether ketones, such as e.g., polyether ketones, polyether ether ketones, etc.

Another group of base polymers comprises polysulfides, such as e.g., polyphenylene sulfide, polyphenylene sulfone, polysulfone, polyether sulfone, etc.

Another group of base polymers comprises polyacetals.

Another group of base polymers comprises celluloses and derivatives such as e.g., nitrates, acetates, acetate-butyrates, etc.

Another group of base polymers comprises vinyl polymers such as e.g., polyvinyl chloride, polyvinyl acetate, polyvinyl alcohol, polyvinyl butyral, polyvinylpyrrolidone, etc.

In addition, aqueous and/or solvent-containing thermoplastic dispersions are advantageously contained.

Elastomers

The base substances involve, e.g., natural rubber, isoprene, butadiene and other rubbers, which may contain chlorine, styrene, nitrile, sulfur, oxygen.

Another group of base polymers comprises silicone elastomers.

In particular, electrically and thermally conductive polymer preparations can be provided with the present invention.

Inorganic Systems

These involve substances such as plaster, mortar, sand, cement preparations, e.g., concrete, and other preparations that can be made conductive by the addition of the above-named additives. In addition, these involve ceramic materials such as AlO, AlN, SiO, SiC, SiN, etc.

The addition of conductivity additives is advantageously produced in the aqueous or solvent-containing phase and with the addition of suitable organic and/or inorganic binders.

Systems that are first produced via an intermediate organic step occupy a special position. Examples thereof are preparations containing phenolic resins, cyanate ester resins, pitch, bitumen, which can be converted to carbon, and polysilanes, polysiloxanes, polysilazanes, which can be converted to SiO, SiC, SiN, SiCN.

It has been found that under suitable mixing conditions in plastic systems, for example in polymer systems, a suspension state of two conductivity additives, including at least one made of carbon (e.g., graphite and CNTs or graphite/carbon black and CNTs, or graphite/silver and CNTs, or graphite/AlN and CNTs), can be produced, which leads to an excellent electrical/thermal conductivity, and influences the mechanical and chemical properties of the polymers to a substantially lesser extent than is the case for a conventionally filled polymer system. The polymer preparations produced with the use of filler combinations according to the invention are characterized by comparatively low viscosities and are thus simpler to process.

These effects are observed in polymers of all types: in resins, in thermoplastics and in elastomers, and, in fact, to the greatest extent independent of the processing method: synergistic effect of CNTs and graphite with one another, and/or with carbon black, and/or with ceramics, and/or with metals, etc. relative to electrical and thermal conductivity.

The special feature of the invention is that the combination of conventional thermally/electrically conductive particles containing CNTs and/or graphite makes it possible to reduce the individual concentrations of the components and thus also the total concentration of the fillers and thus to influence the viscosity to a lesser extent.

The electrical, thermal, rheological properties (of reactive components, of melts, solutions, etc.) that are adjusted cannot be obtained either with graphite or with CNTs alone, for which reason, this clearly involves here a synergistic effect between these two particles and another synergistic effect between the CNT/graphite ‘hybrid’ and other fillers.

An electrical conductivity of approximately 1 mScm⁻¹ can be obtained by means of the addition of 5-20 wt. % of conventional carbon additives in unmodified polymers. With the addition of metallic fillers, e.g., 50-80 wt. % silver, the conductivity can be increased to the range of 10 kScm⁻¹ Here, values of 1 mScm⁻¹ are obtained with additions of approximately 30 wt. %. The obtainable heat conductivities of silver-filled systems lie in the range of 1-3 W/m·K. The use of ceramic particles such as, e.g., BN, Al₂O₃, SiO₂, AlN, BN, etc. alone results generally in values for heat conductivity in the range of 1-5 W/m·K. Of course, the latter systems are not electrically conductive.

Preparations in which the base materials or the first phases, for example, polymers, are chemically optimized and adapted to the respective fillers are particularly advantageous. The optimization provides an actual chemical modification and/or also the mixing or blending of different components, for example polymer components. The use of tempered or graphitized CNTs/graphites is also particularly advantageous. Further advantages can result from the use of mixtures of different graphites and/or the use of mixtures of different CNTs and/or the use of mixtures of different metal particles and/or the use of mixtures of different ceramic particles as well as from the use of other conductivity additives, e.g., carbon black, metal-coated silicates, etc.

Advantageously, other auxiliary substances can be added to the preparations if needed, e.g., in coatings or in casting or kneading compounds. This is not absolutely necessary, of course, for improving the conductivity and is also not desired in all cases.

Thus, the addition of solvents and/or reactive diluting agents influences the viscosity and is especially of great importance and of great advantage in thin coatings.

The addition of bonding agents, such as e.g., silanes, titanates or zirconates, etc. improves the adhesion between fillers and matrix and between preparation and substrate.

The viscosity can be increased by means of rheological additives up to the desired value in order to prevent or to slow down a settling of the CNTs and the other additives, which leads to an increase in storage stability, for example. Mechanical properties can be improved or influenced, in addition, by other particles, such as e.g., talc, mica, quartz, etc.

Reactive Resins

In addition to 1-component systems, the invention also comprises 2-component and multi-component systems. This is understood in the sense that the user of the preparations described here must introduce heat in order to bring about a crosslinking in the case of 1-component systems, and in the case of 2-component and multi-component systems, said components must first be mixed together in order to obtain a crosslinking at RT or by means of introducing heat.

Elastomers

The invention comprises any type of prepared form.

Thermoplastics

The invention comprises preparations of different form, such as, e.g., granulates, powder, dispersions, master batches, etc.

The present invention has a number of special advantages:

The viscosity, for example, of reactive resin, melts, solution, etc. is increased only slightly when compared to the base resin or base hardener, or the polymer melt, etc., due to the relatively small proportion of filler. Thus, the preparations can be handled in principle in the same way as or analogously to the unfilled polymers. This makes possible broader fields of application for the respective preparations.

The use of CNTs and graphite makes possible a considerable cost savings when compared with conventional electrically conductive preparations due to the savings in, e.g., carbon black, silver or AlN.

The low concentration of filler optionally permits a pigmenting with conventional dyes.

In an electrically/thermally conductive preparation based on conventional conductivity additives, it is basically possible to clearly reduce the fraction of additives and to replace these by a substantially smaller fraction of CNTs and graphite without reducing the corresponding conductivity.

A reduction of the fraction of conventional conductivity additive, such as, e.g., graphite, carbon black, silver or AlN by 75%, 50%, 30%, 20% when compared to the initial fraction can be compensated for by an addition of 0.05-1.5% CNTs and 1-15% graphite, in particular 0.3-0.6% CNTs or 5-10% graphite with respect to the total preparation.

The effect can also be transferred to a combination with metal-coated silicates, titanium oxide and to fibers of carbon and metal, etc.

The new preparations can be easily handled and applied, since their total filler content and thus also their viscosity is reduced.

The use of CNTs and graphite makes possible novel preparations, which bring about lower costs than conventional formulations.

The graphite/CNT combination surpasses any other combination of carbons relative to electrical and thermal conductivity and processing, and this is accompanied by a considerable cost savings.

The invention will be described below on the basis of several advantageous, but non-exclusive examples.

### EXAMPLE

### Production of an Electrically Conductive Epoxy Preparation

Filled Epoxy Resin, Particularly Based on Standard Bisphenol A

Graphite is mixed with the base epoxy into a highly concentrated master batch. The

CNTs are also mixed with the base epoxy into a highly concentrated master batch. Both master batches are mixed together and with the base resin in the desired concentrations. The preparation has a viscosity of <10 Pas (plate/plate) and a resistance of <1 kΩ (electrodes at the multimeter immersed, distance ˜1 cm).

Filled Hardener, Particularly Based on Amine

Graphite is mixed with the base hardener into an MB (master batch). The CNTs are also mixed with the base hardener into an MB. Both MBs are mixed together and with the base hardener in the desired concentration. The preparation has a viscosity of <1 Pas (plate/plate) and a resistance of <100Ω (electrodes at the multimeter immersed, distance ˜1 cm).

Hardened Specimen

After mixing the resin and hardener components in the correct ratio, the resin is crosslinked. The hardened specimen (flat bar: 4×10×80) is contacted with the smallest opposite-lying surfaces by means of conductive silver and the resistance is determined with a multimeter. Taking into consideration the geometry of the specimen, a specific resistance of <100Ω cm results with a CNT concentration of <0.6% and a graphite concentration of <10%. The resin/hardener mixture can be easily cast.

The present invention is particularly suitable for heatable coatings and heatable molds. Additional advantageous uses and applications for the present invention are, for example:

Conductive coatings and adhesives:
Flooring that dissipates static electricity
Electromagnetic shielding
Electrically/thermally conductive adhesives for electronics

Conductive casting and kneading compounds:
Molds that dissipates static electricity
Electromagnetic shielding housings
Electrically/thermally conductive housings for electronics

Structural components with improved electrical conductivity:
CFK (carbon-fiber reinforced plastic)
GFK (glass-fiber reinforced plastic)
SFK (synthetic-fiber reinforced plastic)
Prepregs

Initial substances for carbon and ceramic composites

Phenol, cyanate esters, pitch, polysilane

Reactive systems that can be heated and crosslinked via microwaves and/or electrical fields

Hot-melt-type adhesives, tires and the like.

### EXAMPLE

### Production of a Thermally and Electrically Conductive Epoxy Preparation

Filled Epoxy Resins, Particularly Based on Cvcloaliphates

Graphite is mixed with the base epoxy into a highly concentrated master batch. CNTs are also mixed with the base epoxy into a highly concentrated master batch. AlN powder also is mixed with the base epoxy into a highly concentrated master batch. All master batches are mixed together and with the base resin in the desired concentrations. The preparation has a viscosity of <25 Pas (plate/plate) and a resistance of <10 kΩ (electrodes at the multimeter immersed, distance ˜1 cm).

Addition of Latent Hardener, Particularly Based on Anhydride

Graphite is mixed with the base hardener into an MB (master batch). CNTs are also mixed with the base hardener into an MB. AlN powder also is mixed with the base hardener into an MB. All MBs are mixed together and with the base hardener in the desired concentrations. The preparation has a viscosity of <10 Pas (plate/plate) and a resistance of <1 kΩ (electrodes at the multimeter immersed, distance ˜1 cm).

Hardened Specimen

After mixing the resin, hardener and accelerator components in the correct ratio, a 1-component system is obtained that can be stored at RT for several weeks to several months. The resin is hardened at elevated temperature. The specific resistance of an adhesive layer lies in the range of 1-10 kΩ cm and the heat conductivity in the range of 5-6 W/m·K. The CNT concentration is <0.6%, the graphite concentration <10% and the AlN concentration <40%. The resin/hardener mixture (paste) can be easily applied.

### EXAMPLE

### Production of an Electrically Conductive Polyurethane Preparation

Filled Polyols

Graphite is mixed with the base polyol into a highly concentrated master batch. CNTs are also mixed with the base polyol into a highly concentrated master batch. Both master batches are mixed together and with the basic polyol in the desired concentrations. The preparation has a viscosity of <10 Pas (plate/plate) and a resistance of <1 kΩ (electrodes at the multimeter immersed, distance ˜1 cm).

Filled Isocyanates

Graphite is mixed with the base hardener into an MB (master batch). CNTs are also mixed with the base hardener into an MB. Both MBs are mixed together and with the base hardener in the desired concentrations. The preparation has a viscosity of <10 Pas (plate/plate) and a resistance of <1 kΩ (electrodes at the multimeter immersed, distance ˜1 cm).

Hardened Specimen

After mixing the resin and hardener components in the correct ratio, the resin is crosslinked and foamed. The crosslinked specimen has a surface resistance of 1-10 kΩ and an inner resistance of 0.5-5 MΩ.

Very similar results are obtained with the same procedure also for soft elastic polyurethanes.

### EXAMPLE

### Production of an Electrically Conductive Silicone Preparation

Filled Silicones

Graphite is mixed with the base silicone into a highly concentrated master batch. CNTs are also mixed with the base silicone into a highly concentrated master batch. Both master batches are mixed together and with the base silicone in the desired concentrations. The preparation has a viscosity of <50 Pas (plate/plate) and a resistance of <10Ω (electrodes at the multimeter immersed, distance ˜1 cm).

Addition of Crosslinker and Crosslinking

After mixing the resin and crosslinker components in the correct ratio, the silicone resin is crosslinked. The crosslinked specimen has a surface resistance of 100-1000Ω. In general, the material loses flexibility, but remains sufficiently elastic nonetheless.

### EXAMPLE

### Production of an Electrically Conductive Polyvinyl Butyral Preparation

Dissolving the thermoplastic in a solvent

Dispersing the CNTs in a compatible solvent

Dispersing the graphite in a compatible solvent

Mixing the preparations in the desired ratio

Applying a film and drying

The coating has a surface resistance of <10⁵ Ohm.

All preparations with resistances in the range of 1 kΩ advantageously may be heated by applying a voltage of 30-50V.

1. A conductive preparation, in particular an electrically and/or thermally conductive preparation having a first, at least temporarily, liquid phase as well as at least one, preferably at least two, conductivity additive(s) provided in the first phase.

2. The conductive preparation according to claim 1, further characterized in that the first and/or second conductivity additive is/are formed based on carbon.

3. The conductive preparation according to claim 1, further characterized in that the latter has at least one binder and/or at least one additional additive.

4. The conductive preparation according to claim 1, further characterized in that the latter has electrical contacts or means for introducing electrical contacts.

5. The conductive preparation according to claim 1, further characterized in that the latter is formed as a coating and/or as a heating element or for a heating element.

6. The conductive preparation according to claim 1, further characterized in that the latter is applied onto a substrate or is formed so that it can be introduced onto a substrate.

7. A conductive preparation, in particular a plastic preparation, particularly according to claim 1, characterized by at least one base material, in particular a plastic material as well as at least two additives that have been mixed in, whereby at least one additive is formed as a conductivity additive.

8. A method for the production of a conductive preparation, in particular an electrically and/or thermally conductive preparation, particularly a conductive preparation according to claim 1, characterized by the following steps:
A) providing a first, at least temporarily, liquid phase;
B) adding at least one conductivity additive, preferably at least two conductivity additives into the first phase;
C) mixing the first phase and the at least one conductivity additive into a homogeneous state.

9. The method according to claim 8, further characterized in that at least one binder and/or at least one other additive will be added.

10. The method according to claim 8, further characterized in that the conductive preparation is introduced onto a substrate.

11. The method according to claim 8 for the production of a conductive preparation in the form of a coating and/or for the production of a heating element or of an element for a heating element.

12. A method for the production of a conductive preparation, in particular a plastic preparation, particularly a preparation according to claim 1, wherein the method comprises the steps of:
A) providing a first, at least temporarily, liquid phase;
B) adding at least one conductivity additive, preferably at least two conductivity additives into the first phase;
C) mixing the first phase and the at least one conductivity additive into a homogeneous state;
D) wherein at least two additives are added to a base material, in particular a plastic material, wherein at least one additive is formed as a conductivity additive, and wherein the individual components are mixed to form a preparation, in particular a plastic preparation.

13. The method for the production of a conductive preparation according to claim 12, further characterized in that a first additive in the form of a conductivity additive, preferably based on carbon, is mixed with a base material, in that a second additive, in particular a conductivity additive, preferably based on carbon, is mixed with a base material, and in that the two mixture parts are mixed together to form a preparation, in particular a plastic preparation.

14. The method according to claim 8, further characterized in that at least one other material and/or at least one other substance is/are mixed in with the base material and/or the preparation.
